(19) United States
(12) Patent Application Publication
(10) Pub. No.: US 2011/0263786 A1
(43) Pub. Date: Oct. 27, 2011

(54) METHOD FOR PRODUCING N-VINYL PYRROLIDONE/VINYL ACETATE COPOLYMERS

(76) Inventors: Maximilian Angel, Schifferstadt (DE); Angelika Maschke, Mannheim (DE); Karl Kolter, Limburgerhof (DE)

(21) Appl. No.: 13/140,775

(22) PCT Filed: Dec. 18, 2009
(86) PCT No.: PCT/EP2009/067521

§ 371 Date: Jun. 17, 2011

(30) Foreign Application Priority Data
Dec. 19, 2008 (EP) 08172436.1

(51) Int. Cl. C08L 39/06; C08F 226/10

(52) U.S. Cl. 524/548; 526/212

(57) ABSTRACT

The present invention relates to a method for producing N-vinyl pyrrolidone/vinyl acetate copolymers that are soluble in water and that at the same time have a relatively high molecular weight, and to the aqueous polymer solutions and copolymers obtained by way of said method.

The present invention relates to a process for preparing N-vinylpyrrolidone/vinyl acetate copolymers which give clear solutions in water and which simultaneously have a relatively high molecular weight, and to the aqueous polymer solutions and copolymers obtainable with this process.

N-Vinylpyrrolidone/vinyl acetate copolymers and processes for the preparation thereof by free-radical polymerization are known in principle.

Copolymers which give clear solutions in water are desired for many application purposes; i.e. the FNU value of a 5% by weight solution at 25° C. should be ≦20. Copolymers of this type are prepared in an organic solvent, for example in an alcohol or in a mixture of water and organic solvent with a high proportion of organic solvent. Thus, U.S. Pat. No. 5,395,904 describes the polymerization of vinylpyrrolidone and vinyl acetate by the feed method. The solvent used is ethanol or isopropanol, which may comprise up to 50% by weight of water. The polymers are water-soluble, but have only a low molecular weight in the range from 6000 to 50 000 g/mol, corresponding to a K value (according to H. Fikentscher, Cellulose-Chemie, Vol. 13, 1932, pp. 58-64) of from 10 to 40.

Copolymerization in aqueous phase has the advantage over the use of organic solvents in the free-radical copolymerization that water, unlike alcohols, does not intervene as regulator, so that copolymers with high molecular weights (K values>50) can be obtained. It is then possible in principle for the molecular weight to be adjusted specifically by employing suitable regulators. It is also possible by deliberately dispensing with organic solvents to reduce the production costs of production processes existing to date, and to improve the environmental compatibility thereof. Copolymerizations in water do not, however, ordinarily lead to copolymers which give clear solutions in water.

U.S. Pat. No. 4,520,179 and U.S. Pat. No. 4,554,311 describe the copolymerization of N-vinylpyrrolidone and vinyl acetate with tert-butyl peroxypivalate as initiator in water, isopropanol, sec-butanol or water/isopropanol or water/sec-butanol mixtures. The specifically described water/isopropanol mixtures lead, however, to copolymers with a K value of distinctly less than 40.

EP-A-0795567 describes the copolymerization of water-soluble N-vinyllactams such as N-vinylpyrrolidone, and hydrophobic ethylenically unsaturated monomers such as vinyl acetate, in water. In this case, the water-soluble N-vinyllactam and part of the free-radical initiator are introduced into water, and a feed which comprises the water-soluble N-vinyllactam and the hydrobic monomer and in which the water-soluble N-vinyllactam acts as solvent for the hydrophobic monomer is added. The use of the N-vinyllactam as solvent for the hydrophobic monomer and the permanent presence of initiator during the polymerization reaction is presumably intended to prevent precipitation of the hydrophobic monomer in the feed and in the reactor. A disadvantage of this process is that copolymers with any desired ratios by weight of the employed comonomers cannot be obtained, since the water-soluble N-vinyllactam must always be employed in sufficiently large excess in relation to the hydrophobic comonomer, especially when the latter is vinyl acetate, so that it can act as solvent for the latter. Nor is it a trivial matter to meter an undiluted comonomer mixture precisely, but this is important for adjusting the reaction temperature and thus for the properties of the prepared copolymer, which are known to be related to the reaction temperature. It is moreover not unambiguously evident from the EP document what properties the copolymers obtained therewith in fact have.

It was therefore an object of the present invention to provide a process for preparing N-vinylpyrrolidone/vinyl acetate copolymers with which copolymers with a high K value, for example with a K value of at least 45 or preferably at least 50, and simultaneously with a low FNU value, for example with an FNU value not exceeding 20, preferably not exceeding 15, particularly preferably not exceeding 10 and especially not exceeding 7, are obtainable. At the same time, it was intended that the process allow the preparation of copolymers with essentially freely selectable comonomer ratios, for example even of comonomers in which vinyl acetate predominates or at least need not be employed in much less than the stoichiometric amount. It was further intended that the process avoid the metering problems of the process described above. Since N-vinylpyrrolidone/vinyl acetate copolymers are frequently employed in pharmaceutical and cosmetic preparations, the process was additionally intended to allow the preparation of copolymers or copolymer solutions which are essentially free of organic solvents.

It has surprisingly been found that the use of an alcohol/water mixture as solvent, where the alcohol is selected from methanol and ethanol, and a reaction procedure in which part of the N-vinylpyrrolidone is added only after complete addition of the vinyl acetate, leads to copolymers with the desired properties.

The object is accordingly achieved by a process for preparing copolymers which give clear solutions in water from N-vinylpyrrolidone and vinyl acetate by free-radical copolymerization, where, in a first step, a mixture of N-vinylpyrrolidone and vinyl acetate which comprises not more than 95% by weight of the total N-vinylpyrrolidone employed in the copolymerization is copolymerized in a solvent mixture composed of an alcohol which is selected from methanol, ethanol and mixtures thereof, and water in the presence of a free-radical initiator and, in a second step, the copolymerization is continued with addition of the remaining N-vinylpyrrolidone, where the molar ratio of alcohol to water at the time when all the vinyl acetate has been added to the copolymerization, and preferably throughout the addition of vinyl acetate, is from 5.1:1 to 1:2.7, preferably 2.3:1 to 1:1.8.

“Giving clear solutions in water” means in the context of the present invention that the FNU value of a 5% by weight solution of the copolymer at 25° C. is not more than 20. FNU, “formazine nephelometric unit”, is a calibration unit complying with ISO 7027 for turbidity measurements in a scattered light method and is based on a formazin solution (artificial turbidifier; serves as calibration standard).

The statements made below concerning preferred embodiments of the process of the invention and of the polymers obtainable therewith and aqueous solutions thereof apply both separately and, in particular, in combination with one another.

The alcohol employed in the solvent mixture is preferably methanol.

The molar ratio of alcohol to water in the solvent mixture at the time (i.e. at the moment) at which all the vinyl acetate has been added to the copolymerization reaction, and preferably throughout the addition of vinyl acetate, is according to the invention from 5.1:1 to 1:2.7, preferably 2.3:1 to 1:2.2. The molar ratio of alcohol to water in the solvent mixture at the time (i.e. at the moment) at which all the vinyl acetate has been added to the copolymerization reaction, and preferably throughout the addition of vinyl acetate, is particularly preferably from 5.1:1 to 1:1.8 or 2.3:1 to 1:1.8, and in particular 5.1:1 to >1:1.8 or 2.3:1 to >1:1.8. The molar ratio of alcohol to water in the solvent mixture at the time (i.e. at the moment) at which all the vinyl acetate has been added to the copolymerization reaction, and preferably throughout the addition of vinyl acetate, is more preferably from 1.7:1 to >1:1.8, even more preferably 1.4:1 to 1:1.5 and in particular 1.4:1 to 1:1.05.

If methanol is employed as alcohol, the ratio by weight of methanol to water in the solvent mixture at the time (i.e. at the moment) at which all the vinyl acetate has been added to the copolymerization reaction, and preferably throughout the addition of vinyl acetate, is preferably from 90:10 to 20:30, particularly preferably 40:10 to 45:55. The methanol is preferably employed in at least equivalent amounts and in particular in excess, i.e. the ratio by weight of methanol to water in the solvent mixture at the time (i.e. at the moment) at which all the vinyl acetate has been added to the copolymerization reaction, and preferably throughout the addition of vinyl acetate, is preferably at least 1:1, e.g. 90:10 to 10:10 or 40:10 to 10:10, and in particular >1:1, e.g. 90:10 to >10:10 or 40:10 to >10:10. The ratio by weight of methanol to water in the solvent mixture at the time (i.e. at the moment) at which all the vinyl acetate has been added to the copolymerization reaction, and preferably throughout the addition of vinyl acetate, is more preferably from 30:10 to >10:10, even more preferably 70:30 to 55:45 and in particular 70:30 to 63:37.

It is possible in principle with the process of the invention to obtain N-vinylpyrrolidone/vinyl acetate copolymers with any comonomer ratios. With a view to the desired material properties of the copolymers prepared with the process of the invention, however, it is preferred to employ N-vinylpyrrolidone and vinyl acetate in the copolymerization in a total ratio by weight (i.e. ratio by weight of the monomers employed in total) of preferably from 1:1 to 4:1, particularly preferably from 57:43 to 63:37. The ratio by weight of the comonomers is preferably chosen so that the resulting copolymers comprise preferably from 50 to 80% by weight, particularly preferably 57 to 63% by weight, of N-vinylpyrrolidone units and preferably from 20 to 50% by weight, particularly preferably from 37 to 43% by weight, of vinyl acetate units, in each case based on the total weight of the copolymer.

In the process of the invention there is initially copolymerization in a first step of a mixture of N-vinylpyrrolidone and vinyl acetate which comprises no more than 95% by weight, e.g. 50 to 95% by weight or preferably 70 to 95% by weight or particularly preferably 75 to 95% by weight or in particular 80 to 95% by weight, of the total N-vinylpyrrolidone employed in the copolymerization, and the remaining N-vinylpyrrolidone is employed only in a second step. “First” and “second” step refers in this connection only to the relative time sequence of the addition in the copolymerization reaction and does not mean in this connection that the first step is obligatorily the actual first step of the copolymerization. Nor does “second step” mean that this step must follow directly after the “first step”; on the contrary, it merely states that it is subsequent in time to the first step.

Preferably employed in a first step is a mixture of N-vinylpyrrolidone and vinyl acetate which comprises not more than 90% by weight, e.g. 50 to 90% by weight or preferably 70 to 90% by weight or particularly preferably 75 to 90% by weight or in particular 80 to 90% by weight or specifically 85 to 90% by weight; and particularly preferably not more than 85% by weight, e.g. 50 to 85% by weight or preferably 70 to 85% by weight or particularly preferably 75 to 85% by weight or in particular 80 to 85% by weight, of the total N-vinylpyrrolidone employed in the copolymerization.

The reaction temperature in the copolymerization process of the invention is preferably chosen so that it is at least 4° C., particularly preferably at least 5° C. and in particular at least 6° C. lower than the (theoretical) boiling point of vinyl acetate under the prevailing pressure of the reaction. “Reaction temperature”, which is also referred to as “(co)polymerization temperature”, means in this connection the temperature prevailing until all the vinyl acetate, all the N-vinylpyrrolidone and all the free-radical initiator have been added to the reaction. After this, it is perfectly possible for other temperatures also to be adjusted, e.g. during an after-polymerization.

The polymerization can be carried out either under normal pressure (more accurately under ambient pressure which may differ form normal pressure (1013 mbar) depending on the atmospheric pressure) or under the superatmospheric pressure. The superatmospheric pressure may be generated either by autogenous pressure or by a superatmospheric pressure of protective gas or a combination of the two. A suitable protective gas is for example nitrogen or argon, with nitrogen normally being chosen for reasons of cost. Superatmospheric pressure generally means a pressure of >1013 mbar.

If the copolymerization is carried out under superatmospheric pressure, the latter is preferably from 1.1 to 5 bar, particularly preferably 1.2 to 3.5 bar and in particular 1.4 to 2 bar. Since vinyl acetate of course also has a higher boiling point under higher pressure, it is also possible under higher pressures to choose correspondingly higher reaction temperatures than under normal/ambient pressure.

The copolymerization is preferably carried out under ambient pressure or particularly preferably under superatmospheric pressure. It is preferred in this connection in the latter case to adjust, at the start of the polymerization, more accurately before the reaction temperature is adjusted and the temperature is still about 15 to 25° C., a pressure of from 1.1 to 1.6 bar and in particular a pressure of about 1.5 bar. The pressure of the reaction can then increase during the polymerization, owing to the increase in temperature and enlargement of volume, but preferably does not exceed 5 bar and particularly preferably 3.5 bar.

The boiling point of vinyl acetate under normal pressure (1013 mbar) is 72° C. If the reaction is carried out under normal pressure, the reaction temperature correspondingly preferably does not exceed 68° C., particularly preferably does not exceed 67° C. and in particular does not exceed 66° C. At the same time, the reaction temperature is, irrespective of the chosen pressure, preferably at least 40° C., particularly preferably at least 50° C. and in particular at least 60° C., in order to ensure a sufficiently high polymerization rate.

The preferred maximum reaction temperature under higher pressures can easily be ascertained from vinyl acetate pressure/boiling point correlations. Such correlations are detailed for example in the Journal of Chemical and Engineering Data, 10(3), July 1965, pages 214 et seq. As a rough guideline, it can be assumed that the boiling point will increase by 2° when the pressure is increased by about 60 mm Hg. Thus, the boiling point of vinyl acetate is 75° C. under 1.1 bar, about 94° C. under 2 bar, about 114° C. under 3.5 bar and about 129° C. under 5 bar.

Irrespective of the chosen pressure, the copolymerization is preferably carried out at a reaction temperature not exceeding 80° C., e.g. in the range of from 40 to 80° C. or preferably from 50 to 80° C. or in particular from 60 to 80° C.; preferably not exceeding 75° C., e.g. in the range of from 40 to 75° C. or preferably from 50 to 75° C. or in particular from 60 to 75° C.; particularly preferably not exceeding 70° C., e.g. in the range of from 40 to 70° C. or preferably from 50 to 70° C. or in particular from 60 to 70° C.; more preferably not exceeding 68° C., e.g. in the range of from 40 to 68° C. or preferably from 50 to 68° C. or in particular from 60 to 68° C.; even more preferably not exceeding 67° C., e.g. in the range of from 40 to 67° C. or preferably from 50 to 67° C. or in particular from 60 to 67° C.; and in particular not exceeding 66° C., e.g. in the range of from 40 to 66° C. or preferably from 50 to 66° C. or in particular from 60 to 66° C. The reaction is very specifically carried out at from 61 to 66° C.

Free-radical initiators suitable for the free-radical polymerization are in principle all free-radical initiators which are substantially soluble in the reaction medium as prevailing at the time of the addition thereof and have an adequate activity for initiating the polymerization at the given reaction temperatures. “Substantially soluble” means that the solubility of the free-radical initiator is at least 90% by weight, preferably at least 95% by weight and in particular at least 98% by weight, based on the total weight of the free-radical initiator present in each case in the reaction medium, in the reaction medium. Since the composition of the reaction medium may change during the polymerization, the free-radical initiator is preferably substantially soluble throughout the copolymerization in the respective composition of the reaction medium. “Reaction medium” refers in this connection not only to the solvent (mixture) used but also to the reaction mixture per se to which the free-radical initiator is added, since the comonomers used certainly also have a potential for dissolving the latter.

It is possible to employ in the process of the invention a single free-radical initiator or a combination of at least two free-radical initiators. In the latter case, the at least two free-radical initiators can be employed as mixture or preferably separately, simultaneously or successively, e.g. at different times during the reaction.

The free-radical initiators preferably employed are those having a half-life at the given reaction temperature in a 0.1 molar solution of the initiator in chlorobenzene of at least 60 minutes, e.g. from 60 minutes to at most 6 hours, preferably from at least 60 minutes to at most 4 hours and in particular from at least 60 minutes to at most 2.5 hours, and particularly preferably of at least 90 minutes, e.g. from 90 minutes to at most 6 hours, preferably from at least 90 minutes to at most 4 hours and in particular from at least 90 minutes to at most 2.5 hours.

The half-life of a free-radical initiator is the time in which half the free-radical initiator decomposes in a particular solvent at a given temperature. With the exception of the hydroperoxides, the half-life of the free-radical initiators is stated in the relevant literature ordinarily in relation to a 0.1 molar solution of the initiator in chlorobenzene. Half-lives of free-radical initiators at various temperatures are listed for example at http://www.pergan.com.

Thus, when the polymerization is carried out under ambient pressure and thus at a preferred reaction temperature of from 40 to 68° C., the following free-radical initiators are suitable: cumyl peroxyneodecanoate, 1,1,3,3-tetramethylbutyl peroxyneodecanoate, di-n-propyl peroxydicarbonate, tert-amyl peroxyneodecanoate, di(4-tert-butylcyclohexyl) peroxydicarbonate, di(2-ethylhexyl) peroxydicarbonate, tert-butyl peroxyneodecanoate, di(n-butyl) peroxydicarbonate, dicetyl peroxydicarbonate, dimyristyl peroxydicarbonate, 1,1,3,3-tetramethylbutyl peroxypivalate, tert-butyl peroxyneoheptanoate, tert-amyl peroxypivalate, tert-butyl peroxypivalate and di(3,5,5-trimethylhexanoyl) peroxide.

When the polymerization is carried out under higher pressures, higher reaction temperatures are possible. Besides the abovementioned free-radical initiators, therefore, the following initiators are also suitable: dilauroyl peroxide, didecanoyl peroxide, 2,2′-azobisisobutyronitrile, 2,2′-azodi(2-methylbutyronitrile), 2,5-dimethyl-2,5-di(2-ethylhexanoylperoxy)hexane, 1,1,3,3-tetramethylbutyl peroxy-2-ethylhexanoate, tert-amyl peroxy-2-ethyl hexanoate, dibenzoyl peroxide, tert-butyl peroxy-2-ethylhexanoate, tert-butyl peroxydiethylacetate, tert-butyl peroxyisobutyrate, 1,1-di(tert-butylperoxy)-3,3,5-trimethylcyclohexane, 1,1-di(tert-butylperoxy)cyclohexane, tert-amylperoxy 2-ethylhexyl carbonate, tert-butyl peroxy-3,5,5-trimethylhexanoate, 2,2-di(tert-butylperoxy)butane, tert-butylperoxy isopropyl carbonate, tert-butylperoxy 2-ethylhexyl carbonate, tert-butyl peroxyacetate, tert-butyl peroxybenzoate, di-tert-amyl peroxide, dicumyl peroxide, di(2-tert-butylperoxyisopropyl)benzene, 2,5-dimethyl-2,5-di(tert-butylperoxy)hexane, tert-butyl cumyl peroxide, 2,5-dimethyl-2,5-di(tert-butylperoxy)hex-3-yne and di-tert-butyl peroxide.

The free-radical initiators preferably used are those listed above for the case where the polymerization is carried out under ambient pressure. Among these, tert-amyl peroxypivalate and tert-butyl peroxypivalate are preferred. Specific use is made of tert-butyl peroxypivalate.

The amount of initiator used, based on the total amount of monomers employed, is in the range from 0.02 to 10% by weight, preferably 0.05 to 3% by weight, particularly preferably 0.1 to 2% by weight and in particular 0.1 to 1% by weight.

In the process of the invention, the free-radical initiator is ordinarily provided as solution in a suitable solvent. Suitable solvents depend on the nature, more accurately the solubility, of the free-radical initiator used; however, they are preferably selected from the components of the solvent mixture used for the polymerization, i.e. from water, methanol, ethanol and mixtures thereof. Particular preference is given to the use of methanol, ethanol or mixtures thereof and especially methanol.

The initiator concentration in these solutions is in the range of preferably 1 to 30% by weight, particularly preferably 1 to 20% by weight, more preferably 2 to 15% by weight, even more preferably 2 to 11% by weight, in particular 3 to 11% by weight, specifically 4 to 11% by weight and even more specifically 4 to 8% by weight, based on the total weight of solvent and free-radical initiator.

The copolymerization is normally carried out at a neutral pH in the range from 5 to 9. If necessary, the pH is adjusted or maintained by adding a base such as ammonia, NaOH or an acid such as HCl.

The copolymerization process of the invention is preferably designed as a feed process, i.e. as a process in which the comonomers, ordinarily in dissolved form, are metered into the reaction mixture.

In a preferred embodiment, up to 25% by weight, e.g. 5 to 25% by weight or preferably 10 to 25% by weight; preferably up to 20% by weight, e.g. 5 to 20% by weight or preferably 10 to 20% by weight; and particularly preferably up to 15% by weight, e.g. 5 to 15% by weight or preferably 10 to 15% by weight, of a first feed comprising a mixture of all the vinyl acetate employed in the copolymerization with at most 95% by weight of the total of N-vinylpyrrolidone employed in the copolymerization, and the solvent mixture, are initially charged. The initial charge may also comprise part of the free-radical initiator; however, the latter is preferably added separately to the initial charge, preferably after it has been heated to a temperature sufficient to start the polymerization reaction, preferably to the reaction temperature. After the polymerization reaction has started, a start is then made with the addition, continuously or a little at a time, of the remaining part of the first feed and with the addition, continuously or a little at a time, of further free-radical initiator (second feed). The free-radical initiator is ordinarily provided in a suitable solvent. Suitable solvents depend on the nature of the free-radical initiator used; however, they are preferably selected from the components of the solvent mixture used for the polymerization, i.e. from water, methanol, ethanol and mixtures thereof, in particular from methanol, ethanol and mixtures thereof and specifically methanol. The metering in generally takes place over a period of several hours, e.g. from 4 to 14 hours, preferably 4 to 12 hours, particularly preferably 5 to 10 hours. The addition of the first feed is in this connection preferably finished more quickly than that of the second feed. The finish of the addition of the first feed is followed by the addition, continuously or a little at a time, of a third feed which comprises the remaining N-vinylpyrrolidone, preferably dissolved in a suitable solvent. Suitable solvents are the components of the solvent mixture used for the polymerization, and mixtures thereof, with preference for the use of water. The third feed can be metered in over a period of from 0.5 to 3 hours, preferably 1 to 2 hours. The addition of the third feed is in this connection preferably finished more quickly than that of the second feed. The finish of the addition of the second feed is preferably followed by after-polymerization, i.e. the reaction temperature and, if appropriate, the reaction pressure are maintained for a further time, or the temperature is increased somewhat, e.g. by 2 to 15° C. or 5 to 15° C., e.g. for 0.5 to 12 hours, preferably for 0.5 to 5 hours and particularly preferably for 0.5 to 2 hours. The addition, continuously or a little at a time, of a fourth feed which comprises free-radical initiator, ordinarily in a suitable solvent, is then started. This free-radical initiator may in this case correspond to that of the second feed or be different therefrom. It is preferably the same free-radical initiator as used in the second feed or else for initiating the polymerization in the initial charge. Concerning suitable solvents, reference is made to that stated concerning the second feed. The metering in of the fourth feed normally takes place over a period of a plurality of hours, e.g. from 2 to 14 hours, preferably 3 to 12 hours, particularly preferably 4 to 6 hours. After addition of the fourth feed is finished, the alcohol of the solvent mixture is depleted from the reaction mixture as completely as possible, possibly for example by distillation (e.g. azeotropic distillation with the water present in the mixture) and/or steam distillation. It is self-evident that when the alcohol is removed by distillation, the water content in the reaction mixture also changes, for example because water is also removed azeotropically or because water is introduced through the steam distillation. Finally, the reaction product freed of alcohol is adjusted to the desired solids content by adding water.

The statements made above concerning the addition rates and reaction times relate to batches on the 1 to 1000 kilogram scale and are chosen so that control of the reaction temperature is ensured. For batches which are substantially larger or substantially smaller it may be more favorable in some circumstances to change the addition rates and reaction times.

All additions/meterings in preferably take place continuously.

In a preferred embodiment, part of the alcohol is removed even before starting the addition of the fourth feed, for example by a distillation by heating the reaction mixture to the required temperature, and only then is addition of the fourth feed started. It is self-evident that when the alcohol is removed by distillation, the water content in the reaction mixture may also change, for example because water is also removed azeotropically or physically. It is preferred in this connection for from 5 to 35% by weight, particularly preferably 10 to 20% by weight, of the solvent (mixture) to be removed, based on the total amount of solvent mixture (i.e. water plus alcohol) which is present in the reaction mixture before removal of this alcohol portion.

To achieve high K values it is advantageous to start the polymerization with a monomer concentration which is as high as possible. The total monomer content in the first feed and in the initial charge is therefore preferably at least 45% by weight, e.g. 45 to 80% by weight, preferably 45 to 70% by weight and in particular 45 to 60% by weight; particularly preferably at least 50% by weight, e.g. 50 to 80% by weight, preferably 50 to 70% by weight and in particular 50 to 60% by weight, and in particular at least 55% by weight, e.g. 55 to 80% by weight, preferably 55 to 70% by weight and in particular 55 to 60% by weight, based on the total weight of all the starting materials and products present in the initial charge and in the first feed.

The content of unreacted monomers and polymers at the end of the addition of the first feed is preferably at least 44% by weight, e.g. 44 to 80% by weight, preferably 44 to 70% by weight and in particular 44 to 60% by weight; particularly preferably at least 49% by weight, e.g. 49 to 80% by weight, preferably 49 to 70% by weight and in particular 49 to 60% by weight, and in particular at least 54% by weight, e.g. 54 to 80% by weight, preferably 54 to 70% by weight and in particular 54 to 60% by weight, based on the total weight of all the starting materials and products present in the reaction zone at the end of the addition of the first feed (i.e. unreacted monomers, polymers formed, initiator, solvent).

Reaction vessels suitable for carrying out the process of the invention are all reactors suitable for copolymerization in liquid phase, such as, for example, temperature-controllable reaction vessels with various feed lines.

A particularly preferred embodiment of the process of the invention comprises the following steps:
(i) initial charging of part of the total N-vinylpyrrolidone, vinyl acetate, alcohol and water employed in the copolymerization (in other words initial charging of part of feed 1 described below) in a reaction zone and heating of the mixture, preferably to a temperature sufficient to initiate the polymerization reaction, and particularly preferably to the desired reaction temperature;
(ii) addition of part of the total of free-radical initiator employed in the copolymerization, optionally in a suitable solvent, to the initial charge from step (i);
(iii) continuous addition of feed 1 which comprises part of the total N-vinylpyrrolidone employed in the copolymerization and the remaining amount of the vinyl acetate employed in the copolymerization, and part of the alcohol and water employed in the copolymerization, and simultaneously continuous addition of a feed 2 which comprises part of the total free-radical initiator employed in the copolymerization, optionally in a suitable solvent, where the duration of the addition of feed 2 is longer than the duration of the addition of feed 1, into the reaction zone;
   with the proviso that the amount of N-vinylpyrrolidone employed in steps (i) and (iii) is not more than 95% by weight, preferably not more than 90% by weight, of the total N-vinylpyrrolidone employed in the copolymerization; and with the proviso that the molar ratio of alcohol to water at the time at which all of feed 1 has been fed into the copolymerization, and preferably throughout the addition of feed 1, is from 5.1:1 to 1:2.7, preferably 2.3:1 to 1:1.8;
(iv) after complete addition of feed 1 continuous addition of a feed 3 which comprises the remainder of the total N-vinylpyrrolidone employed in the copolymerization, and optionally a solvent, into the reaction zone, where the duration of addition of feed 2 is preferably longer than the duration of the addition of feed 3;
(v) optionally after-polymerization of the reaction mixture obtained in step (iv) and/or optionally removal of part of the solvent mixture from the reaction zone;
(vi) continuous addition of a feed 4 which comprises a free-radical initiator, optionally in a suitable solvent; and
(vii) after addition of feed 4 is complete, at least partial removal of the alcohol from the reaction mixture to obtain a substantially aqueous polymer solution.

In step (i) there is initial charging preferably of up to 25% by weight, e.g. 5 to 25% by weight or preferably 10 to 25% by weight; particularly preferably up to 20% by weight, e.g. 5 to 20% by weight or preferably 10 to 20% by weight; and in particular up to 15% by weight, e.g. 5 to 15% by weight or preferably 10 to 15% by weight; of feed 1 which comprises a mixture of all the vinyl acetate employed in the copolymerization with not more than 95% by weight of the total N-vinylpyrrolidone employed in the copolymerization, and the solvent mixture. In other words, in step (i) there is initial charging preferably of up to 25% by weight, e.g. 5 to 25% by weight or preferably 10 to 25% by weight; particularly preferably up to 20% by weight, e.g. 5 to 20% by weight or preferably 10 to 20% by weight; and in particular up to 15% by weight, e.g. 5 to 15% by weight or preferably 10 to 15% by weight; of the vinyl acetate employed in steps (i) and (iii), preferably up to 25% by weight, e.g. 5 to 25% by weight or preferably 10 to 25% by weight; particularly preferably up to 20% by weight, e.g. 5 to 20% by weight or preferably 10 to 20% by weight; and in particular up to 15% by weight, e.g. 5 to 15% by weight or preferably 10 to 15% by weight; of the N-vinylpyrrolidone employed in steps (i) and (iii), preferably up to 25% by weight, e.g. 5 to 25% by weight or preferably 10 to 25% by weight; particularly preferably up to 20% by weight, e.g. 5 to 20% by weight or preferably 10 to 20% by weight; and in particular up to 15% by weight, e.g. 5 to 15% by weight or preferably 10 to 15% by weight; of the water employed in steps (i) and (iii) and preferably up to 25% by weight, e.g. 5 to 25% by weight or preferably 10 to 25% by weight; particularly preferably up to 20% by weight, e.g. 5 to 20% by weight or preferably 10 to 20% by weight; and in particular up to 15% by weight, e.g. 5 to 15% by weight or preferably 10 to 15% by weight; of the alcohol employed in steps (i) and (iii).

It is then possible if desired to adjust a superatmospheric pressure; concerning the preferred values for the superatmospheric pressure, reference is made to the above statements.

In step (i), the initially charged mixture is preferably heated to a temperature sufficient to initiate the polymerization reaction, and particularly preferably to the desired reaction temperature. If the polymerization is carried out under ambient pressure, the initially charged mixture in step (i) is preferably heated to a temperature of from 40 to 68° C., particularly preferably from 50 to 68° C. and in particular from 60 to 67° C. Higher temperatures can be adjusted under higher pressures; concerning more precise details, reference is made to the above statements.

In step (ii), the free-radical initiator is employed preferably dissolved in a suitable solvent. Suitable solvents depend on the nature of the free-radical initiator used; however, they are preferably selected from the components of the solvent mixture used for the polymerization, that is to say from water, methanol, ethanol and mixtures thereof. Methanol, ethanol or a mixture thereof, and in particular methanol, are particularly preferably used as solvent. The concentration of the free-radical initiator in the solvent is preferably from 1 to 20% by weight, particularly preferably 2 to 11% by weight, more preferably 3 to 11% by weight, even more preferably 4 to 11% by weight, and in particular 4 to 8% by weight, based on the total weight of the solution of free-radical initiator and solvent.

In step (ii), preferably not more than 10% by weight, e.g. 0.5 to 10% by weight or preferably 1 to 10% by weight, and particularly preferably not more than 5% by weight, e.g. 0.5 to 5% by weight or preferably 1 to 5% by weight, of the total free-radical initiator employed in steps (ii) and (iii) is employed.

As soon as the polymerization starts through addition of the free-radical initiator (“starting” of the polymerization), which is manifested for example by a turbidity or a change in viscosity, the addition of feeds 1 and 2 is started (step (iii)).

The free-radical initiator employed in feed 2 in step (iii) is preferably the same as in step (ii). The free-radical initiator is employed preferably dissolved in a suitable solvent in step (iii) too. Concerning suitable and preferred solvents, and the concentration of the free-radical initiator in the solution, reference is made to the statements concerning step (ii).

Addition of the two feeds 1 and 2 generally takes place over a period of several hours, e.g. from 4 to 14 hours, preferably 4 to 12 hours, particularly preferably 5 to 10 hours. Addition of feed 1 is in this case finished more quickly than that of feed 2. Addition of feed 1 preferably amounts to from 4 to 10 hours, particularly preferably 5 to 8 hours and in particular 5 to 6 hours. Addition of feed 2 preferably amounts to from 5 to 14 hours, particularly preferably 5 to 12 hours, more preferably 6 to 10 hours and in particular 7 to 9 hours.

The amount of N-vinylpyrrolidone employed in steps (i) and (iii) is not more than 95% by weight, e.g. 50 to 95% by weight or preferably 70 to 95% by weight or particularly preferably 75 to 95% by weight or in particular 80 to 95% by weight; preferably not more than 90% by weight, e.g. 50 to 90% by weight or preferably 70 to 90% by weight or particularly preferably 75 to 90% by weight or in particular 80 to 90% by weight; and particularly preferably not more than 85% by weight, e.g. 50 to 85% by weight or preferably 70 to 85% by weight or particularly preferably 75 to 85% by weight or in particular 80 to 85% by weight, of the total N-vinylpyrrolidone employed [i.e. in steps (i), (iii) and (iv)] in the copolymerization.

The molar ratio of alcohol to water in the solvent mixture at the time (i.e. at the moment) at which all the vinyl acetate has been fed into the copolymerization reaction [i.e. at the end of step (iii)], and preferably throughout the addition of vinyl acetate [i.e. throughout step (iii)] is according to the invention from 5.1:1 to 1:2.7, preferably 2.3:1 to 1:2.2. The molar ratio of alcohol to water in the solvent mixture at the time (i.e. at the moment) at which all the vinyl acetate has been fed into the copolymerization reaction [i.e. at the end of step (iii)], and preferably throughout the addition of vinyl acetate [i.e. throughout step (iii)] is particularly preferably from 5.1:1 to 1:1.8 or 2.3:1 to 1:1.8, and in particular 5.1:1 to >1:1.8 or 2.3:1 to >1:1.8. The molar ratio of alcohol to water in the solvent mixture at the time (i.e. at the moment) at which all the vinyl acetate has been fed into the copolymerization reaction [i.e. at the end of step (iii)], and preferably throughout the addition of vinyl acetate [i.e. throughout step (iii)] is more preferably from 1.7:1 to >1:1.8, even more preferably 1.4:1 to 1:1.5 and in particular 1.4:1 to 1:1.05.

If methanol is employed as alcohol, the ratio by weight of methanol to water at the time at which all of feed 1 has been fed into the copolymerization [i.e. at the end of step (iii)] and preferably throughout the addition of vinyl acetate [i.e. throughout step (iii)] is preferably from 90:10 to 20:30, particularly preferably 40:10 to 45:55. Methanol is preferably employed in at least equivalent amounts and in particular in excess, i.e. the ratio by weight of methanol to water in the solvent mixture at the time (i.e. at the moment) at which all the vinyl acetate has been fed into the copolymerization reaction [i.e. at the end of step (iii)], and preferably throughout the addition of vinyl acetate [i.e. throughout step (iii)] is preferably at least 1:1, e.g. 90:10 to 10:10 or 40:10 to 10:10, and in particular >1:1, e.g. 90:10 to >10:10 or 40:10 to >10:10. The ratio by weight of methanol to water in the solvent mixture at the time (i.e. at the moment) [i.e. at the end of step (iii)] at which all the vinyl acetate has been fed into the copolymerization reaction, and preferably throughout the addition of vinyl acetate [i.e. throughout step (iii)] is more preferably from 30:10 to 10:10, even more preferably 70:30 to 55:45 and in particular 70:30 to 63:37.

Complete finishing of the addition of feed 1 is followed by continuous addition of feed 3 which comprises the remaining N-vinylpyrrolidone, preferably dissolved in a suitable solvent. Suitable solvents in this case too are the components of the solvent mixture used for the polymerization, and mixtures thereof, with preference for use of water.

The metering in of feed 3 can take place over a period of from 0.5 to 3 hours, preferably 1 to 2 hours. The addition of feed 3 is in this case preferably finished more quickly than that of feed 2.

A finishing of the addition of feed 2 is preferably followed by after-polymerization [step (iv)], i.e. the reaction temperature and, if appropriate, the reaction pressure are maintained for a further period, or the temperature is increased somewhat, e.g. by 2 to 15° C. or 5 to 15° C., e.g. for 0.5 to 12 hours, preferably for 0.5 to 5 hours and particularly preferably for 0.5 to 2 hours.

Alternatively or additionally (i.e. after the after-polymerization), preferably part of the alcohol is removed from the reaction mixture, for example by distillation by heating the reaction mixture to the necessary temperature, if appropriate under reduced pressure. It is self-evident that, when the alcohol is removed by distillation the water content in the reaction mixture may also change, for example because water is also removed azeotropically or physically. It is preferred in this case to remove from 5 to 35% by weight, particularly preferably 10 to 20% by weight, of the solvent (mixture), based on the total amount of solvent mixture (i.e. water plus alcohol) present in the reaction mixture before removal of part of the alcohol.

The process of the invention preferably comprises step (iv). In this case, step (iv) particularly preferably comprises both the after-polymerization and the partial removal of the alcohol, where appropriate mixed with water.

Subsequently, i.e. after step (iii) or, if comprised, after step (iv), continuous addition of feed 4 which comprises free-radical initiator, ordinarily in a suitable solvent, is started. This free-radical initiator employed in step (v) can in this connection correspond to that in feed 2 or be different therefrom. It is preferably the same free-radical initiator as used in feed 2 or else to initiate the polymerization in the initial charge. Concerning suitable solvents, reference is made to that stated concerning feed 2. The metering in of feed 4 normally takes place over a period of a plurality of hours, e.g. from 2 to 14 hours, preferably 3 to 12 hours, particularly preferably 4 to 6 hours.

After the addition of feed 4 is finished, the alcohol of the solvent mixture is at least partly depleted from the reaction mixture and is preferably removed as completely as possible, possibly for example by distillation (also azeotropic distillation with the water present in the mixture) and/or steam distillation [step (vi)]. It is self-evident that, on removal of the alcohol by distillation the water content in the reaction mixture also changes, for example because water is also removed azeotropically or physically or because water is introduced by the steam distillation.

Finally, the reaction product freed of the alcohol is adjusted by addition of water to the desired solids content, e.g. to a solids content of from 15 to 55% by weight or preferably 25 to 45% by weight or particularly preferably 25 to 40% by weight or in particular 25 to 35% by weight, based on the total weight of the reaction product. This reaction product is preferably a substantially aqueous polymer solution. “Substantially aqueous” means in this connection that the solution comprises not more than 2% by weight, preferably not more than 1% by weight, more preferably not more than 0.5% by weight, even more preferably not more than 0.2% by weight and in particular not more than 0.1% by weight of alcohol (i.e. methanol and/or ethanol), based on the total weight of the polymer solution.

The statements made above concerning the addition rates and reaction times relate to batches on the 1 to 1000 kilogram scale and are chosen so that control of the reaction temperature is ensured. For batches which are substantially larger or substantially smaller it may be more favorable in some circumstances to change the addition rates and reaction times.

To achieve high K values it is advantageous to start the polymerization with a monomer concentration which is as high as possible. The total monomer content in the feed 1 and in the initial charge is therefore preferably at least 45% by weight, e.g. 45 to 80, preferably 45 to 70 and in particular 45 to 60% by weight; particularly preferably at least 50% by weight, e.g. 50 to 80, preferably 50 to 70 and in particular 50 to 60% by weight, and in particular at least 55% by weight, e.g. 55 to 80, preferably 55 to 70 and in particular 55 to 60% by weight, based on the total weight of all the starting materials and products present in the initial charge and in the feed 1.

The content of unreacted monomers and polymers at the end of the addition of feed 1 is preferably at least 44% by weight, e.g. 44 to 80, preferably 44 to 70 and in particular 44 to 60% by weight; particularly preferably at least 49% by weight, e.g. 49 to 80, preferably 49 to 70 and in particular 49 to 60% by weight, and in particular at least 54% by weight, e.g. 54 to 80, preferably 54 to 70 and in particular 54 to 60% by weight, based on the total weight of all the starting materials and products present in the reaction zone at the end of the addition of the feed 1 (i.e. unreacted monomers, polymers formed, initiator, solvent).

The aqueous solutions of the copolymer can if desired be converted into solid powders by a drying process corresponding to the prior art. Suitable drying processes are processes suitable for drying from aqueous solution. Preferred processes are for example spray drying, fluidized spray drying, drum drying and belt drying. It is likewise possible to use freeze drying or freeze concentration.

It is possible with the process of the invention to prepare N-vinylpyrrolidone/vinyl acetate copolymers with a relatively high molecular weight and at the same time good solubility in water. At the same time, the copolymers and aqueous solutions thereof have a very low, in fact negligible, residual alcohol content.

Thus, the copolymers prepared according to the invention have a K value (determined at 25° C. in a 1% by weight aqueous or ethanolic solution) of preferably at least 45, particularly preferably of at least 50, more preferably of at least 52, specifically of at least 55 and even more specifically of at least 56. Determination of the K value is described in H. Fikentscher “Systematik der Cellulosen auf Grund ihrer Viskosität in Lösung”, Cellulose-Chemie 13 (1932), 58-64 and 71-74, and Encyclopedia of Chemical Technology, Vol. 21, 2^{nd} edition, 427-428 (1970).

At the same time, the copolymers have very good solubility in water. The measure used for the solubility of the copolymers in water is the nephelometric turbidity unit FNU, which is measured on a 5% by weight aqueous solution of the polymer at 25° C. and is determined by calibration with formazin as artificial turbidity agent. The exact method is indicated in the following examples. The copolymers obtained according to the invention have a low FNU value not exceeding 20, preferably not exceeding 15, particularly preferably not exceeding 10 and in particular not exceeding 7.

The copolymers prepared according to the invention have a residual alcohol content preferably not exceeding 0.5% by weight, particularly preferably not exceeding 0.2% by weight and in particular not exceeding 0.1% by weight, based on the total weight of the copolymer. The statements about the residual alcohol content relate in this case to values obtained by gas chromatography.

The process of the invention is preferably used to prepare N-vinylpyrrolidone/vinyl acetate copolymers with a ratio by weight of N-vinylpyrrolidone units to vinyl acetate units of from 1:1 to 4:1, a K value of at least 45 and an FNU value not exceeding 20, particularly preferably for preparing N-vinylpyrrolidone/vinyl acetate copolymers with a ratio by weight of N-vinylpyrrolidone units to vinyl acetate units of from 1:1 to 4:1, preferably 1:1 to 2:1, a K value of at least 50, and an FNU value not exceeding 15 and in particular for preparing N-vinylpyrrolidone/vinyl acetate copolymers with a ratio by weight of N-vinylpyrrolidone units to vinyl acetate units of from 1:1 to 4:1, preferably 1:1 to 2:1, a K value of at least 52, and an FNU value not exceeding 15, preferably not exceeding 7.

The invention further relates to an aqueous polymer solution obtainable by the process of the invention. Concerning suitable and preferred copolymers obtainable by the process of the invention, reference is made to the above statements. The aqueous polymer solution preferably comprises not more than 0.5% by weight, preferably not more than 0.2% by weight and in particular not more than 0.1% by weight, of alcohol based on the total weight of the solution.

The invention further relates to an N-vinylpyrrolidone/vinyl acetate copolymer obtainable by the process of the invention and having a ratio by weight of N-vinylpyrrolidone units to vinyl acetate units of from 1:1 to 2:1, a K value of at least 45 and an FNU value not exceeding 20. The copolymer of the invention preferably has a ratio by weight of N-vinylpyrrolidone units to vinyl acetate units of from 1:1 to 2:1, a K value of at least 50 and an FNU value not exceeding 15. The copolymer of the invention has in particular a ratio by weight of N-vinylpyrrolidone units to vinyl acetate units of from 1:1 to 2:1, a K value of at least 52 and an FNU value not exceeding 15, preferably not exceeding 7.

The copolymers obtained by the process of the invention on the one hand act as thickeners in aqueous medium, and on the other hand are able to form water-soluble films. They are therefore used in particular in cosmetic and pharmaceutical preparations, for example as additives or carriers in hair lacquer, hair-setting composition or hair spray; in cosmetic preparations for the skin, as skin adhesive gels or as immunochemicals, e.g. as catheter coatings. Specific pharmaceutical applications of the copolymers of the invention comprise in particular use as wet or dry binders, matrix release-slowing agents or coating release-slowing agents (for slow-release dosage forms), gel formers, instant release coatings and tablet-coating aids. The copolymers prepared according to the invention can additionally be used as agrochemical auxiliaries, for example for seed coating or soil release fertilizer formulations or as aids in the production of fish feed pellets.

Because of the high dispersive action of the copolymers prepared according to the invention, both for organic and for inorganic pigments, the copolymers of the invention are suitable as rust preventers or rust removers from metallic surfaces, as scale preventers or scale removers, as dispersants in dye pigment dispersions, for example in printing inks. In this connection, reference may be made to the use of the copolymers of the invention for ink jet recording media, ink pen and ballpoint pen pastes.

Also of interest for industrial applications is the great tendency of the copolymers of the invention to form complexes with organic compounds (e.g. lower hydrocarbons, phenols, tannin and various antioxidants), with enzymes and proteins or with other organic polymers. The copolymers of the invention additionally form complexes with inorganic compounds, in particular with hydrogen peroxide, halides, metals or metal salts. Accordingly, the copolymers of the invention can be used to remove tannin, phenols, proteins or polyvalent cations from aqueous medium, in ion exchangers, for stabilizing hydrogen peroxide, for example in disinfectants, for stabilizing antioxidants, for example in preservatives, as polymeric coligand for metal complexes of reversible oxygen absorption or for catalysts. The copolymers of the invention can additionally be used for stabilizing metal colloids. In this connection, reference may be made to the use of the copolymers of the invention as noble metal crystallization nuclei for silver precipitation and as stabilizer for silver halide emulsions.

The copolymers of the invention are additionally suitable for modifying surface and interface properties. They can be employed for example for making surfaces hydrophilic and can accordingly be used as textile assistants, for example as stripping and leveling agents for textile colorings, as whiteners in textile printing etc. Because of the surface-modifying effect, the compositions of the invention can be used as coatings, e.g. for polyolefins, for glass and glass fibers. Because of their surfactant effect, they are additionally used as protective colloids, for example for stabilizing metal colloids or for free-radical aqueous emulsion polymerization. In this connection, reference may also be made to the use of the copolymers of the invention as auxiliaries in recovering mineral oil from oil-containing water, as auxiliaries in mineral oil and natural gas extraction, and mineral oil and natural gas transport. The copolymers of the invention are additionally used as auxiliaries in the purification of wastewaters, whether as flocculants or for removing color and oil residues from wastewater. The copolymers of the invention can additionally be used as phase-transfer catalysts and as solubilizers.

The copolymers of the invention are additionally used in the coloring of polyolefins, as color-transfer inhibitors, as color-mixing inhibitors for photographic diffusion transfer materials, as coupling agents for dyes, as auxiliaries for lithography, for photoimaging, for diazotypes, as auxiliaries for metal casting and metal hardening, as auxiliaries for metal quenching baths, as auxiliaries in gas analysis, as constituent in ceramic binders, as paper auxiliary for special papers, as binder in paper coating slips and as binder constituent in plaster bandages.

The copolymers of the invention are additionally suitable as proton conductors and can be employed in electrically conducting layers, e.g. in charge transfer cathodes, as solid electrolytes, e.g. in solid batteries such as lithium batteries. It is possible to produce from the copolymers of the invention contact lenses, synthetic fibers, air filters, e.g. cigarette filters, or membranes. The copolymers of the invention are additionally used in heat-resistant layers, heat-sensitive layers and heat-sensitive resistors.

The examples detailed below are intended to illustrate the invention without restricting it, however.

### EXAMPLES

The turbidity of the aqueous copolymer solution was determined by nephelometric turbidity measurement (ISO 7027). In this method, light scattered by the measurement solution is investigated by photometry, the light scattering being caused by the interaction between the light beams and the particles or droplets in the solution, whose number and size account for the degree of turbidity. The measured quantity in this connection is the nephelometric turbidity unit FNU which is measured on a 5% by weight aqueous solution of the polymer at 25° C. and is determined by calibration with formazin as artificial turbidity agent. A higher FNU value means a more turbid solution.

The residual methanol content was determined by headspace gas chromatography in analogy to European Pharmacopia (Ph. Eur. 6.0, 2008, Chapter 2.4.24, Identification and quantification of residual solvents, System B). For this purpose, an approx. 50 mg sample was weighed into a headspace sample vial in 6 ml of dimethylacetamide. This sample vial was equilibrated at 105° C. in the headspace sampler for 45 min, and the headspace was injected by pressure injection (6 s injection time) into the gas chromatograph. The gas chromatographic separation took place on a DB-wax column (50 m length, 0.32 mm ID, 1.2 μm film thickness) with the following temperature gradient: 50° C. for 20 min isothermal, 50-165° C. at 6° C./min and 165° C. for 20 min isothermal. Detection took place in a flame ionization detector. The calibration was carried out with an external standard.

### PREPARATION EXAMPLES

### Example 1

The apparatus used was a 2 l glass reactor with reflux condenser, anchor stirrer and 3 metering vessels (=feed 1 to feed 4).

The reactor was flushed with nitrogen for 30 min. It was then heated by means of an external temperature control system to an internal temperature of 63° C. When the internal temperature reached 61° C., addition 1 was added to the initial charge. After the reaction started, feeds 1 and 2 were started. Feed 1 was continuously metered in over the course of 5.5 h and feed 2 over the course of 8 h. After the addition of feed 1 was complete, feed 3 was started and metered in over the course of 1.5 h. After the addition of feed 2 was complete, after-polymerization was carried out at an internal temperature of 63° C. for 1 h. This was followed by heating to an external temperature of 120° C., and 80 g of solvent were distilled out. After the distillation was complete, the reaction mixture was cooled to an internal temperature of 65° C. When the internal temperature reached 65° C., feed 4 was started and metered in over the course of 5 h. After the addition of feed 4 was complete, the reaction mixture was heated to an external temperature of 120° C. and subjected to a steam distillation in order to deplete the organic solvent. After an internal temperature of 98° C. was reached, distillation was continued for 4 h. The reaction mixture was then cooled to room temperature and adjusted with deionized water to a 30% by weight solids content.

| Classification | Amount | Starting material | Content |
|---|---|---|---|
| Initial charge | 79.42 g of feed 1 | | |
| Feed 1 | Total: 722.30 g | | |
| | 231.70 g | N-Vinylpyrrolidone | 100.00% |
| | 173.80 g | Vinyl acetate | 100.00% |
| | 205.80 g | Methanol | 100.00% |
| | 111.00 g | Deionized water | 100.00% |
| Addition 1 | Total: 0.90 g | | |
| | 0.84 g | Methanol | 100.00% |
| | 0.06 g | tert-Butyl perpivalate | 75.00% |
| Feed 2 | Total: 34.70 g | | |
| | 32.36 g | Methanol | 100.00% |
| | 2.34 g | tert-Butyl perpivalate | 75.00% |
| Feed 3 | Total: 223.40 g | | |
| | 40.10 g | N-Vinylpyrrolidone | 100.00% |
| | 183.30 g | Deionized water | 100.00% |
| Feed 4 | Total: 20.60 g | | |
| | 19.20 g | Methanol | 100.00% |
| | 1.40 g | tert-Butyl perpivalate | 75.00% |

### Example 2 (Comparative)

The procedure was as in example 1, but the water content of the formulation was replaced by methanol.

### Example 3

The procedure was as in example 1, but the water/methanol ratio in feeds 1 and 2 was altered as follows: 73% by weight methanol:27% by weight water instead of 68.6% by weight methanol:31.4% by weight water.

### Example 4 (Comparative)

The procedure was as in example 1, but the water/methanol ratio in feeds 1 and 2 was altered as follows: 38% by weight methanol:62% by weight water instead of 68.6% by weight methanol:31.4% by weight water.

### Example 5 (Comparative)

The procedure was as in example 1, but the N-vinylpyrrolidone from feed 3 was added to feed 1.

### Example 6

The apparatus used was a pressure vessel 2 feed vessels, reflux condenser and distillation vessel.

The initial charge was evacuated and 5 bar of nitrogen were injected, followed by decompression and evacuation. Then 0.5 bar of nitrogen was injected, and the internal temperature was raised to 70° C. When an internal temperature of 65° C. was reached, addition 1 was added to the initial charge. After the reaction started, feed 1 was added over the course of 5.5 h, and feed 2 over the course of 8 h, to the initial charge. After the addition of feed 1 was complete, feed 3 was metered in over the course of 1.5 h. After the addition of feed 2 was complete, after-polymerization was carried out at 80° C. for 1 h. The vessel was decompressed, the condenser was opened for distillation, and about 70 l of methanol were distilled out (external temperature setting 120° C.). The vessel was then closed, 0.3 bar of nitrogen was injected, and the internal temperature was adjusted to 80° C. When 80° C. was reached, feed 4 was metered in over the course of 5 h. The vessel was decompressed, the condenser was opened for distillation, and a steam distillation was carried out with 70 kg/h until an internal temperature of 98° C. was reached. Distillation was then continued for 1 h. The vessel was cooled to RT, and the reaction mixture was adjusted with deionized water to a 30% by weight solids content.

| Classification | Amount | Starting material | Content |
|---|---|---|---|
| Initial charge | Total: 79.42 kg | | |
| | 79.42 kg of feed 1 | | |
| Feed 1 | Total: 722.30 kg | | |
| | 231.70 kg | N-Vinylpyrrolidone | 100.00% |
| | 173.80 kg | Vinyl acetate | 100.00% |
| | 205.80 kg | Methanol | 100.00% |
| | 111.00 kg | Deionized water | 100.00% |
| Addition 1 | Total: 0.90 kg | | |
| | 0.84 kg | Methanol | 100.00% |
| | 0.06 kg | tert-Butyl perpivalate | 75.00% |
| Feed 2 | Total: 34.70 kg | | |
| | 32.36 kg | Methanol | 100.00% |
| | 2.34 kg | tert-Butyl perpivalate | 75.00% |
| Feed 3 | Total: 223.40 kg | | |
| | 40.10 kg | N-Vinylpyrrolidone | 100.00% |
| | 183.30 kg | Deionized water | 100.00% |
| Feed 4 | Total: 20.60 kg | | |
| | 19.20 kg | Methanol | 100.00% |
| | 1.40 kg | tert-Butyl perpivalate | 75.00% |

### Example 7

The procedure was as in example 6, but the steam distillation was prolonged to 2 hours after an internal temperature of 98° C. was reached.

The properties of the copolymers obtained in examples 1 to 7 are detailed in the table A below.

TABLE A

| | | | | Residual alcohol |
|---|---|---|---|---|
| Example | SC* (wt %) | K value** | FNU*** | [ppm] |
| 1 | 28.6 | 55.4 | 13 | 800 |
| 2 (comparative) | 29.4 | 43.4 | 4 | 900 |
| 3 | 28.5 | 56.3 | 14 | 1100 |
| 4 (comparative) | 26.5 | 67.9 | 107 | 1000 |
| 5 (comparative) | 29.0 | 55.2 | 123 | 1200 |
| 6 | 31.1 | 52.2 | 6.5 | 4000 |
| 7 | 30.6 | 52.4 | 6.4 | 1400 |

*Solids content
**measured on 1% by weight solution in water
***measured on 5% by weight solution in water

### USE EXAMPLES

The binder effect of an excipient for wet granulation for producing tablets is characterized by its influence on the particle size of the granules and compressibility, tablet hardness and friability.

The effectiveness of the N-vinylpyrrolidone/vinyl acetate copolymer prepared in example 7 of the invention as binder in wet granulation was investigated by means of two different granulation techniques (granulation with a binder solution in an intensive mixer and in a fluidized bed) and compared with the binder effect of an N-vinylpyrrolidone/vinyl acetate copolymer with a ratio by weight of N-vinylpyrrolidone units to vinyl acetate units of about 6:4 and a K value of about 30 (hereinafter: “comparative copolymer”).

### Use Example 1

### Granulation in an Intensive Mixer

The granulation was carried out in an intensive mixer (Diosna V 50 Osnabruck, Germany). The composition of the granules is shown in table 1.

TABLE 1
Composition of the granules

| Formulation | Composition |
|---|---|
| Calcium hydrogen phosphate | 85% by weight |
| Lactose | 12% by weight |
| Binder | 3% by weight |

(% by weight based on the total weight of calcium hydrogen phosphate, lactose and binder)

Calcium hydrogen phosphate (filler) and lactose were mixed in the Diosna mixer for 1 min (200 rpm stirrer/2200 rpm chopper). The binder (spray-dried N-vinylpyrrolidone/vinyl acetate copolymer from example 7 of the invention or comparative copolymer with K value of 30) was dissolved in water and added as 18.4% strength solution to the stirred container while stirring continuously for 4 min. Addition of the binder solution to the mixture was followed by a mixing time of 2 min. The stirrer speed was then raised to 1500 rpm for 30 s. The moistened composition was subsequently passed through a sieve with a mesh width of 0.8 mm, and the wet granules were dried on trays for at least 12 hours.

For the tabletting, Kollidon® CL (BASF, disintegrant) and magnesium stearate (lubricant), in accordance with the formulation in table 2, were added. The complete composition was passed through a sieve with a mesh width of 0.8 mm and mixed in a Turbula mixer for 5 min. The granular mixture was then tabletted in an eccentric press (EK0 eccentric press, Korsch, Berlin, Germany) with a compressive force of 10 kN and 18 kN.

TABLE 2
Tabletting mixture

| Formulation | Composition |
|---|---|
| Granules | 95.2% by weight |
| Kollidon ® CL | 4.3% by weight |
| Magnesium stearate | 0.5% by weight |

(% by weight based on the total weight of granules, Kollidon CL and magnesium stearate)

TABLE 3
Tablet properties

| Compressive | | | |
|---|---|---|---|
| force | Binder | Hardness [N] | Friability [%] |
| 10 kN | comparative | 39 | 1.00 |
| | according to the | 82 | 0.42 |
| | invention | | |
| 18 kN | comparative | 97 | 0.31 |
| | according to the | 150 | 0.25 |
| | invention | | |

Analysis of the produced tablets (see table 3) shows that as the K value and molecular mass of the polymer are increased, the hardness of the tablets increases and the tablet attrition becomes less.

### Use Example 2

### Fluidized Bed Granulation

Vitamin C (as active ingredient) was granulated in a fluidized bed (Glatt GPCG 3.1, Glatt, Binzen, Germany) with a polymer solution of the invention and a comparative polymer solution (in analogy to use example 1) (see table 4 for fomulations).

TABLE 4
Granule composition

| Formulation | 1 | 2 |
|---|---|---|
| Vitamin C | 97% by weight | 98% by weight |
| Binder | 3% by weight | 1.5% by weight |
| Concentration of binder solution | 8% by weight | 15% by weight |

(% by weight based on total weight of vitamin C and binder)

TABLE 5
Granulation conditions
Production parameters

| | |
|---|---|
| Top Spray | |
| Nozzle | 1 mm |
| Product temperature | 30° C. |
| Volumetric flow | 80 m³/h |
| Exit air flap | 33% |
| Spraying pressure | 1.5 bar |
| Spraying rate | 20 g/min |

Vitamin C was granulated in a top spray process using the conditions indicated in table 5. The binder solution was sprayed onto the vitamin C over the course of 20 min. After addition of the binder solution to the vitamin C, the temperature was raised to 65° C. and dried for 10 min. The moist granules were dried on trays for 12 hours.

As shown in table 6 below, the average particle size (d (05)) of the granules can be distinctly increased by increasing the K value.

TABLE 6
Influence of the binder viscosity on the particle size d[05] in
fluidized bed granulation

| K value | 1.5% binder d (0.5) [μm] | 3% binder d (0.5) [μm] |
|---|---|---|
| 30 (comparative) | 88.8 | 98.7 |
| 52 (according to the | 151.8 | 252 |
| invention) | | |

### Use Example 3

### Tabletting of Fluidized Bed Granules

The granules produced with a 1.5% by weight polymer content from use example 2 were compressed to tablets, and the effect of the K value of the polymer on the tablet hardness, attrition and disintegration was assessed.

3% Kollidon® CL-SF (BASF, disintegrant) and 1% magnesium stearate were added to the granules and mixed in a Turbula mixer for 5 min. The complete composition was passed through a sieve with a mesh width of 0.8 mm and then the granular mixture was tabletted in an eccentric press (EK0 eccentric press, Korsch, Berlin, Germany) with a compressive force of 10 kN.

The hardness of the tablets increases as the K value of the polymer employed in the binder solution increases (see table 7). The increase in the K value additionally leads to lower friability.

TABLE 7
Influence of the K value of the binder in fluidized bed granulation
on the tablet properties

| Compressive force | K value | Hardness [N] | Friability [%] |
|---|---|---|---|
| 10 kN | 30 (comparative) | 65 | 1.2 |
| | 52 (according to the | 82 | 0.7 |
| | invention) | | |

1.-18. (canceled)

19. A process for preparing copolymers which give clear solutions in water from N-vinylpyrrolidone and vinyl acetate by free-radical copolymerization, where, in a first step, a mixture of N-vinylpyrrolidone and vinyl acetate which comprises not more than 95% by weight of the total N-vinylpyrrolidone employed in the copolymerization is copolymerized in a solvent mixture composed of an alcohol which is selected from methanol, ethanol and mixtures thereof, and water in the presence of a free-radical initiator and, in a second step, the copolymerization is continued with addition of the remaining N-vinylpyrrolidone, wherein the molar ratio of alcohol to water at the time when all the vinyl acetate has been added to the copolymerization is from 5.1:1 to 1:2.7, preferably 2.3:1 to 1:1.8.

20. The process according to claim 19, wherein the alcohol is methanol.

21. The process according to claim 19, wherein the molar ratio of alcohol to water at the time at which all the vinyl acetate has been added to the copolymerization is from 1.4:1 to 1:1.5.

22. The process according to claim 19, wherein N-vinylpyrrolidone and vinyl acetate are employed in a total ratio by weight of from 1:1 to 4:1.

23. The process according to claim 19, wherein the mixture of N-vinylpyrrolidone and vinyl acetate employed in the first step comprises not more than 90% by weight of the total N-vinylpyrrolidone employed in the copolymerization.

24. The process according to claim 19, wherein the free-radical initiator is selected from those having a half-life at the reaction temperature of the copolymerization of at least 60 minutes and at most 6 hours, preferably of at least 90 minutes and at most 4 hours.

25. The process according to claim 19, wherein the reaction temperature in the copolymerization is chosen so that it is at least 4° C. lower than the boiling point of vinyl acetate under the prevailing pressure of the reaction.

26. The process according to claim 19, comprising the following steps:
(i) initial charging of part of the total N-vinylpyrrolidone, vinyl acetate, alcohol and water employed in the copolymerization in a reaction zone and heating of the mixture,
(ii) addition of part of the total of free-radical initiator employed in the copolymerization, optionally in a suitable solvent, to the initial charge from step (i);
(iii) continuous addition of feed 1 which comprises part of the total N-vinylpyrrolidone employed in the copolymerization and the remaining amount of the vinyl acetate employed in the copolymerization, and part of the alcohol and water employed in the copolymerization, and simultaneously continuous addition of a feed 2 which comprises part of the total free-radical initiator employed in the copolymerization, optionally in a suitable solvent, wherein the duration of the addition of feed 2 is longer than the duration of the addition of feed 1, into the reaction zone;
with the proviso that the amount of N-vinylpyrrolidone employed in steps (i) and (iii) is not more than 95% by weight, preferably not more than 90% by weight, of the total N-vinylpyrrolidone employed in the copolymerization; and
with the proviso that the molar ratio of alcohol to water at the time at which all of feed 1 has been fed into the copolymerization, is from 5.1:1 to 1:2.7, preferably 2.3:1 to 1:1.8;
(iv) after complete addition of feed 1 continuous addition of a feed 3 which comprises the remainder of the total N-vinylpyrrolidone employed in the copolymerization, and optionally a solvent, into the reaction zone;
(v) optionally after-polymerization of the reaction mixture obtained in step (iv) and/or optionally removal of part of the solvent mixture from the reaction zone;
(vi) continuous addition of a feed 4 which comprises a free-radical initiator, optionally in a suitable solvent; and
(vii) after addition of feed 4 is complete, at least partial removal of the alcohol from the reaction mixture to obtain a substantially aqueous polymer solution.

27. The process according to claim 26, wherein feed 3 employed in step (iv) comprises N-vinylpyrrolidone and water.

28. The process according to claim 26, wherein the free-radical initiator in step (ii), (iii) and (vi) is employed in an alcohol which is selected from methanol, ethanol and mixtures thereof.

29. The process according to claim 26, wherein the total monomer content in feed 1 and in the initial charge is at least 45% by weight, preferably at least 50% by weight.

30. The process according to claim 26, wherein the content of unreacted monomers and polymers at the end of the addition of feed 1 is at least 44% by weight, preferably at least 49% by weight, based on the total weight of all the starting materials and products present in the reaction zone at the end of the addition of the first feed.

31. The process according to claim 19, for preparing N-vinylpyrrolidone/vinyl acetate copolymers with a ratio by weight of N-vinylpyrrolidone units to vinyl acetate units of from 1:1 to 4:1, a K value of at least 45 and an FNU value of at most 20.

32. The process according to claim 31, for preparing N-vinylpyrrolidone/vinyl acetate copolymers with a ratio by weight of N-vinylpyrrolidone units to vinyl acetate units of from 1:1 to 4:1, preferably 1:1 to 2:1, a K value of at least 50 and an FNU value of at most 15.

33. An aqueous polymer solution obtainable by a process according to claim 19.

34. The aqueous polymer solution according to claim 33, which comprises not more than 0.5% by weight, preferably not more than 0.2% by weight, of alcohol based on the total weight of the solution.

35. An N-vinylpyrrolidone/vinyl acetate copolymer obtainable by a process according to claim 19, with a ratio by weight of N-vinylpyrrolidone units to vinyl acetate units of from 1:1 to 2:1, a K value of at least 45 and an FNU value of at most 20.

36. The N-vinylpyrrolidone/vinyl acetate copolymer according to claim 35, with a K value of at least 50 and an FNU value of at most 15.
